(19) United States
(12) Patent Application Publication
(10) Pub. No.: US 2026/0292432 A1
(43) Pub. Date: Sep. 24, 2026

(54) SYSTEM FOR SUPPLYING STEREOPHONIC SOUND TO REAL SPACE BY SELECTIVELY TRACING MOVING OBJECT IN VIDEO

(71) Applicant: ASTNOVA INC., Seoul (KR)

(72) Inventor: Sang Gook HAN, Cheongju-si (KR)

(21) Appl. No.: 19/475,518

(22) PCT Filed: Dec. 20, 2023
(86) PCT No.: PCT/KR2023/021076

§ 371 Date: Oct. 15, 2025

(30) Foreign Application Priority Data
Apr. 26, 2023 (KR) 10-2023-0055025

(51) Int. Cl. H04S 7/00; G06T 7/20

(52) U.S. Cl. CPC H04S 7/303; G06T 7/20; H04S 2400/11

(57) ABSTRACT

The present invention relates to a system for supplying stereophonic sound to real space by selectively tracing moving object in video. The system comprises a technical idea including a video source acquisition unit that acquires video information applied to a display unit; an video processing unit that selectively extracts a moving object within video from the video information and tracks and recognizes a moving trace of the moving object; and a sound source processing unit that extracts an audio source for comparison with an image from the video information, separately extracts a moving sound source originating from the moving object, and selectively transmits the moving sound source to a plurality of speaker units.

### TECHNICAL FIELD

The present invention relates to a system for providing multi-dimensional sound to a user located within a physical space. More specifically, the invention pertains to a system divides moving objects from non-moving objects in a video, separately extracts only signals caused by moving objects, and individually transmits the corresponding sounds to physically divided individual speakers, thereby providing individual multi-dimensional sounds according to the movement of the moving object.

### Background Art

According to ReportLinker, a global market research firm, the global audio equipment market size is projected to reach approximately USD 7.74 billion in April, 2023 (approx. KRW 10.24 trillion). This represents a growth of approximately 6.76% compared to 2022, when the market was estimated at USD 7.25 billion (approx. KRW 9.6 trillion).

ReportLinker predicts continued growth in the speaker market, which includes home audio equipment such as subwoofers, wall-mounted speakers, and TV soundbars, with an expected compound annual growth rate (CAGR) of 6.7% through 2027.

Notably, the home audio market has shown prominent growth. During the COVID-19 pandemic, increased in-home content consumption via TV led to greater consumer attention toward audio devices. ReportLinker notes that “users are increasingly aware and demanding in terms of sound quality,” and that “they are willing to invest more in speakers.”

The digital entertainment group (DEG) in the U.S. also reported an increase in overall consumer spending on home entertainment, including TVs and audio devices. As TV sales grew during the pandemic, the audio market expanded as well. ReportLinker notes that “with rising popularity in home entertainment audio equipment, manufacturers such as Samsung, LG, Sony, and Bose are launching new products and platforms.”

This is why major TV manufacturers like Samsung and LG are increasingly enhancing their soundbar products—to provide a richer audio experience in conjunction with TVs, and to increase sales in the audio segment.

Recently, as Samsung and LG compete with new OLED TVs, they are also introducing new soundbar models, showcasing their advanced technology in the process (refer to Edaily news article dated Mar. 11, 2023).

A relevant prior art of the present invention is Korean Patent No. 10-1919508, titled “Three-dimensional sound providing method and apparatus using sound signal generation in a virtual space” (Patent document 1).

Patent document 1 provides a device for supplying three-dimensional sound by generating a sound signal in a virtual space comprising a frequency energy analyzer that analyzes the frequency energy of a sound source, a sound source category determiner that compares the frequency energy of each frequency band analyzed by the frequency energy analyzer to determine a sound source category, a virtual sound source placer that sets the virtual sound source arrangement in a virtual space in response to the instrument arrangement information of the sound source category, a virtual sound source generator that generates a virtual sound source by upmixing and downmixing, and an equalizer that equalizes each virtual sound source according to the positional relationship between the virtual sound source set in the virtual space and the listener.

Another relevant prior art is Korean Patent No. 10-1682105, titled “Method and apparatus for controlling spatial sound” (Patent document 2).

One embodiment of the Patent document 2 outputs a graphical user interface screen in the form of one or more corresponding objects arranged in a virtual space, and when input information for adjusting the size of the virtual space is received, adjusts at least one of the extinction time, vibration width, and time difference of each sound signal included in a multi-channel sound signal based on the input information and outputs the adjusted signal, thereby providing a three-dimensional surround effect without having to have a separate additional speaker for implementing 3D sound. In addition, it provides a method and device for controlling three-dimensional sound that can provide a listener with a sense of presence as if listening to music in various actual performance venues.

Another relevant prior art is Korean Patent No. 10-1534295, titled “Method and apparatus for providing multi-view video and 3D spatial sound” (Patent document 3).

One embodiment of the Patent document 3 displays a stereoscopic image and a multi-channel image in which one or more corresponding objects are arranged in a virtual space in a preset channel display area, outputs a multi-channel audio signal corresponding to the multi-channel image, and, when variation information about the corresponding object is recognized, generates a reconstructed stereoscopic image by reconstructing the stereoscopic image based on the variation information, and outputs the reconstructed stereoscopic image by controlling the output of each audio signal included in the multi-channel audio signal, thereby displaying a 3D spatial sense. In addition, it provides a method and device for providing multi-viewer images and 3D stereoscopic sound that can provide a three-dimensional and realistic surround effect without having to provide separate additional speakers for implementing 3D sound.
(Patent document 1) Korean Patent Registration No. 10-1919508
(Patent document 2) Korean Patent Registration No. 10-1682105
(Patent document 3) Korean Patent Registration No. 10-1534295

### DISCLOSURE

### Technical Problem

According to the present invention, the system for providing multi-dimensional sound in a physical space using selective tracking of moving objects in video was devised to address the limitations of conventional technologies. The invention aims to solve the following problems:

To provide multi-dimensional sound to users based on video-derived information.

To design a multi-dimensional sound centered on a specific object within the video, that is, a moving object, and the sound originating from the moving object.

To provide users with multi-dimensional sound effects centered around moving objects based on moving parts within video.

The problems to be solved by the present invention are not limited to those mentioned above, and other problems not mentioned can be clearly understood by those skilled in the art from the description below.

### Technical Solution

The system for supplying stereophonic sound to real space by selectively tracing moving object in video according to the present invention has the following problem-solving means to solve the above-mentioned problem.

The present invention relates to a system for supplying stereophonic sound to real space by selectively tracing moving object in video. The system comprises a video source acquisition unit that acquires video information applied to a display unit; a video processing unit that selectively extracts a moving object within video from the video information and tracks and recognizes a moving trace of the moving object; and a sound source processing unit that extracts an audio source for comparison with an image from the video information, separately extracts a moving sound source originating from the moving object, and selectively transmits the moving sound source to a plurality of speaker units.

According to the present invention, the video processing unit comprises a video extractor configured to extract video separately from audio within the video content, a space recognizer configured to independently extract a background space video from the video extracted by the video extractor and a moving object recognizer configured to independently extract and recognize the moving object from the video extracted by the video extractor.

The space recognizer is configured to recognize the spatial movement of the moving object through the background space video divided into a plurality of virtual grids within the background space video and through the segmented background space video.

The video processing unit further comprises a moving trace recognizer configured to recognize and track trajectory information of the moving object in the background space video in three dimensions based on the area of the plurality of virtual grids that the moving object occupies in the background space video and coordinate information of the plurality of virtual grids to which the moving object is transferred in the background space video.

The sound source processing unit comprises a moving sound source separator configured to extract sound source in contrast to the video from the video information, and separately extract the moving sound originating from the moving object.

The sound source processing unit further comprises a multi-channel allocator configured to divide the moving sound source of the moving object extracted separately by the moving sound source separator into a plurality of spatial signals, and selectively assigns an individual channel to each of the plurality of spatial signals.

The sound source processing unit further comprises a physical space synchronizer configured to arrange each of the plurality of speaker units according to preset space designation information within the physical space of the room in which the user is located, and selectively assigns the space signal to each of the plurality of speaker units.

The sound source processing unit further comprises a moving object sound source tracer configured to recognize the trajectory information recognized by the moving trace recognizer in three dimensions, selectively transmits each of the plurality of spatial signals to which the individual channels are selectively assigned to the plurality of speaker units arranged in the physical space, and provides the user with a multi-dimensional sound through the plurality of speaker units in the physical space in accordance with the trajectory information of the moving object moving.

The physical space synchronizer is configured to define a predetermined positioned zone virtually within the room where the user is located, and arrange the multiple speaker units in front, rear, left, and right directions around the predetermined positioned zone based on the predefined spatial configuration information.

The multiple virtual grids form the plurality of grid-shaped virtual grids in the upper, lower, left, and right directions of the video information applied to the display unit, and is characterized in that the unit cells of the grid-shaped virtual grid can be selectively expanded or reduced.

### ADVANTAGEOUS EFFECTS

The system for supplying stereophonic sound to real space by selectively tracing moving object in video, according to the present invention, has the following advantages:

First, it enables the delivery of a multi-dimensional sound effect focused on key visual elements within the video, especially those that users are most attentive to.

Second, it segments moving and non-moving parts within the video using video codec-based analysis and extracts sounds associated with moving parts to provide selective multi-dimensional sound effects.

Third, it tracks the movement traces of moving objects and delivers discrete signals to individual speakers surrounding the user, thereby generating multi-dimensional sound effects.

The effects mentioned above are not exhaustive, and further advantages will be apparent to those skilled in the art from the detailed description that follows.

### DESCRIPTION OF DRAWINGS

FIG. 1 is a conceptual diagram illustrating an example arrangement in which a speaker unit is placed in conjunction with a display unit within the physical space where the user is located according to an embodiment of the present invention.

FIG. 2 is a conceptual diagram showing the extraction of visual and audio information from video content according to an embodiment of the present invention.

FIG. 3 is a conceptual diagram illustrating the selective extraction of a moving object from the video according to an embodiment of the present invention.

FIG. 4 is a conceptual diagram illustrating the separation and extraction of a moving signal from a moving object and a reflection signal from a reflection object according to an embodiment of the present invention.

FIG. 5 is a conceptual diagram showing the acquisition of a ghost object according to an embodiment of the present invention.

FIG. 6 is a block diagram illustrating each configuration of the system according to an embodiment of the present invention.

FIG. 7 is a block diagram showing a video processing unit and its subcomponents according to an embodiment of the present invention.

FIG. 8 is a block diagram showing a sound source processing unit and its subcomponents according to an embodiment of the present invention.

FIG. 9 is a conceptual diagram illustrating the function of a detaching module according to an embodiment of the present invention.

### BEST MODE FOR INVENTION

According to an embodiment of the present invention, the system can undergo various modifications and be implemented in multiple embodiments. Specific embodiments are illustrated in the accompanying drawings and described in detail below. However, these embodiments are not intended to limit the invention to the particular forms disclosed, but rather to cover all modifications, equivalents, and alternatives falling within the scope of the invention.

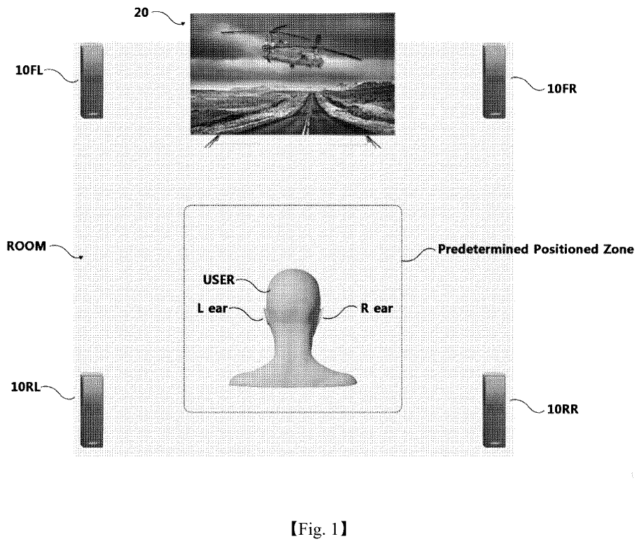

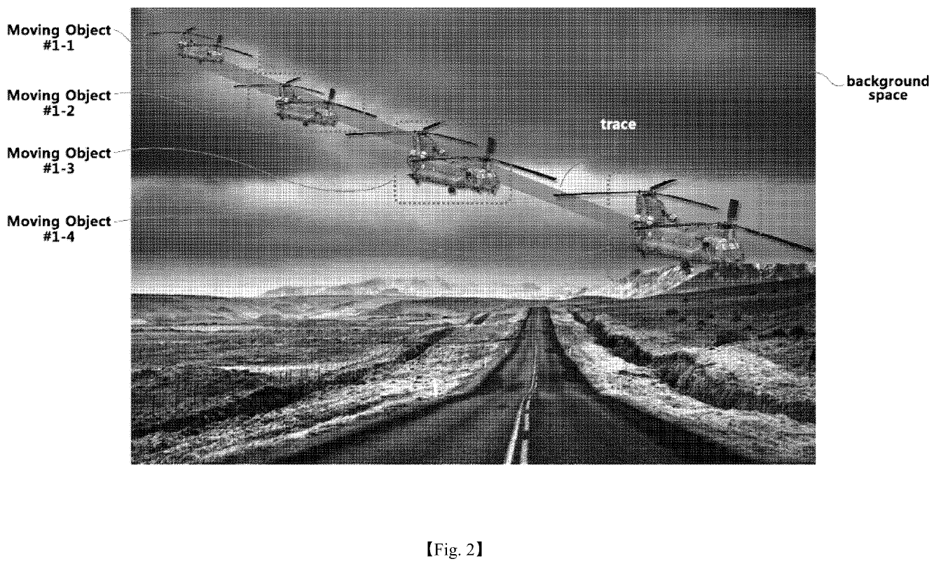

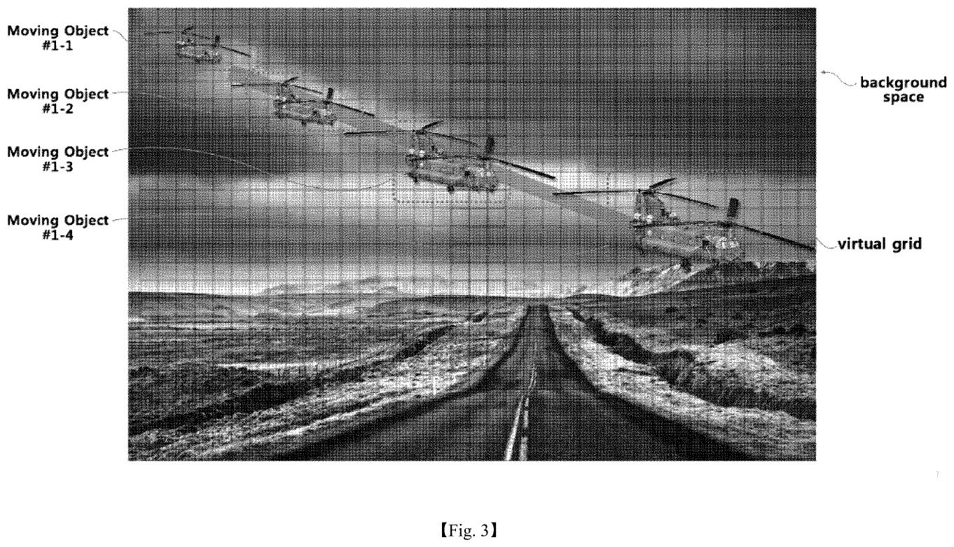

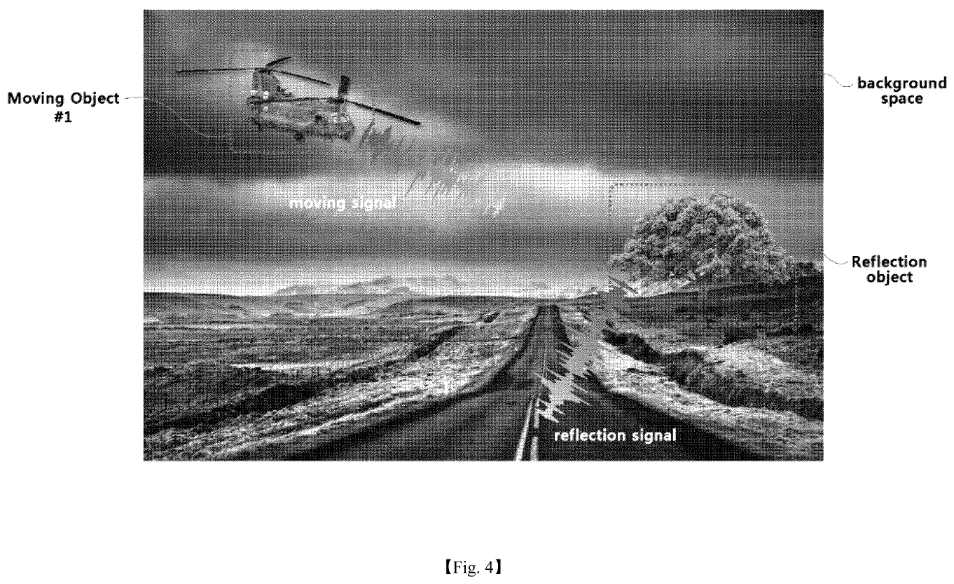

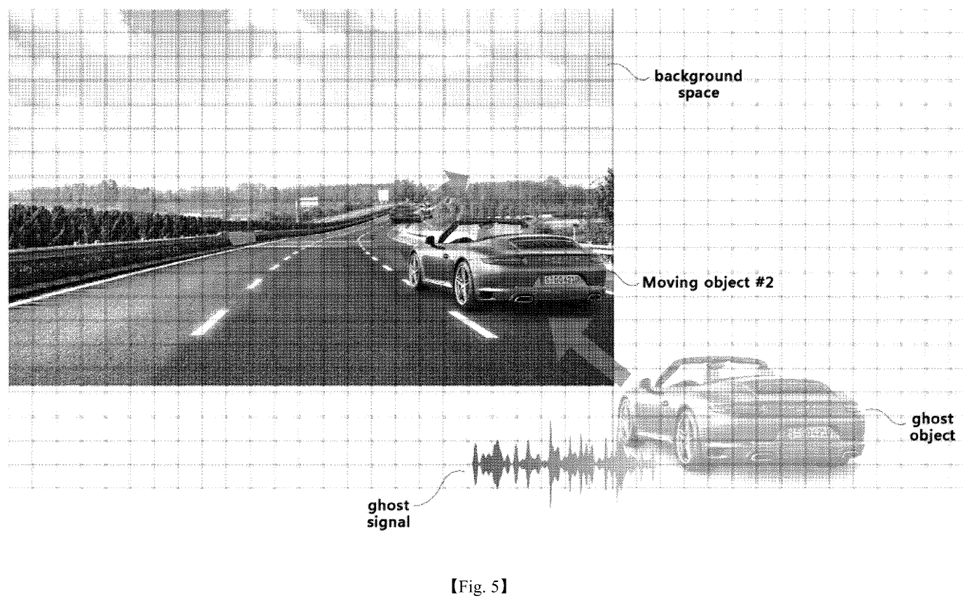

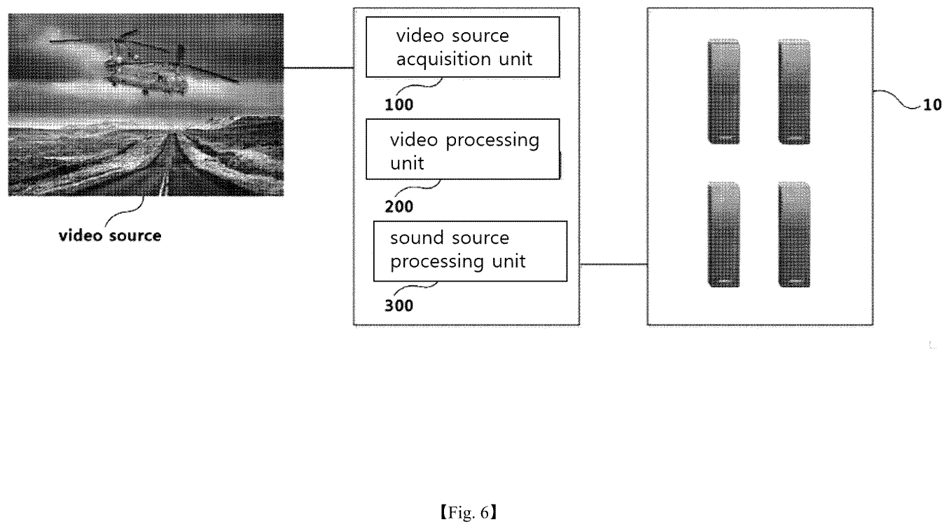

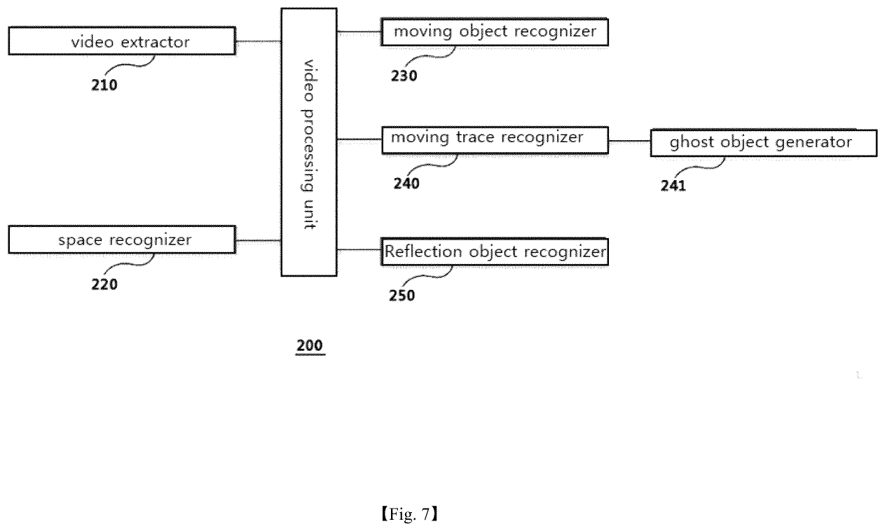

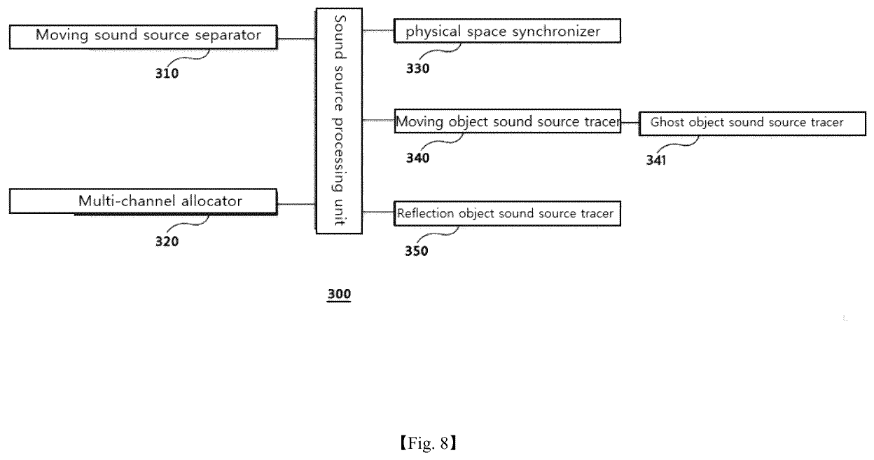

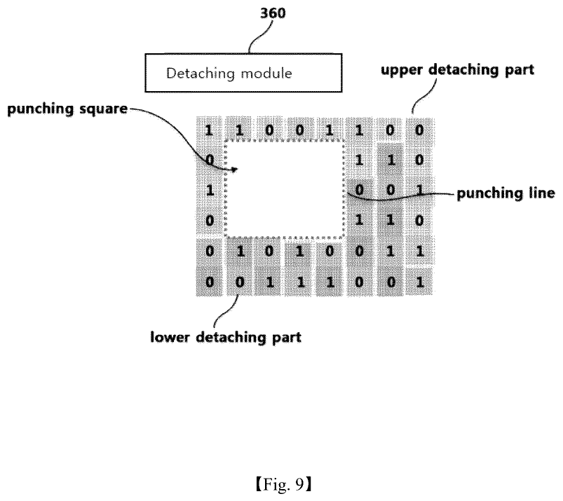

FIG. 1 is a conceptual diagram illustrating an example arrangement in which a speaker unit is placed in conjunction with a display unit within the physical space where the user is located according to an embodiment of the present invention. FIG. 2 is a conceptual diagram showing the extraction of visual and audio information from video content according to an embodiment of the present invention. FIG. 3 is a conceptual diagram illustrating the selective extraction of a moving object from the video according to an embodiment of the present invention. FIG. 4 is a conceptual diagram illustrating the separation and extraction of a moving signal from a moving object and a reflection signal from a reflection object according to an embodiment of the present invention. FIG. 5 is a conceptual diagram showing the acquisition of a ghost object according to an embodiment of the present invention. FIG. 6 is a block diagram illustrating each configuration of the system according to an embodiment of the present invention. FIG. 7 is a block diagram showing the video processing unit and its subcomponents according to an embodiment of the present invention. FIG. 8 is a block diagram showing the sound source processing unit and its subcomponents according to an embodiment of the present invention. FIG. 9 is a conceptual diagram illustrating the function of a detaching module according to an embodiment of the present invention.

The terms “unit” and “module” as used in this patent specification should be understood as a component defined as a functional unit implemented through a program or software.

As shown in FIG. 1, the present invention corresponds to a system for sourcing video information authorized to a display unit (20) such as a TV, beam projector, or other projector, and providing stereoscopic sound within a physical space (see room in FIG. 1) in which multiple speaker units (10: 10FL, 10FR, 10RL, 10RR) are arranged.

The system may be implemented as a chip embedded within the display unit (20), installed software, or provided through a USB or HDMI connection by the applicant. It gains access to the video content and performs the three-dimensional sound processing described below.

As shown in FIG. 6, the system may include a video source acquisition unit (100), a video processing unit (200), and a sound source processing unit (300).

The video source acquisition unit (100) is configured to acquire video information applied to the display unit (20) by sourcing it at the same time as access authority is granted to the display unit (20), as described above.

The video source acquisition unit (100) is preferably configured to acquire video information before it is displayed on a screen in the display unit (20), and is provided with a technical function to provide multi-dimensional sound to multiple speaker units (10) through separation of sound sources and analysis of images using the acquired video information.

The video information acquired by the video source acquisition unit (100) is processed as source information by the video processing unit (200) and sound source processing unit (300) described below.

The video processing unit (200), as described above is configured to selectively extract a moving object within the image from video information and recognize the moving trace of the moving object, i.e., the trace or trajectory of the moving object.

The video processing unit (200) recognizes and distinguishes between a background space video corresponding to the background and a moving object that is not a background from the video information. This is based on a method of transmitting compressed data separately for parts with little change and parts with a lot of change between frames in a video, among the standard codec compression technologies, and focuses on parts with a lot of change between frames, but can capture typical patterns of parts with a lot of change, such as people, cars, aircraft, animals, or other objects that move within the video and attract the user's attention. That is, the method by which the video processing unit (200) extracts a moving object from a background space video is to additionally acquire recognition through a change in the position of the moving object along with a change in the size of the moving object, as described below in addition to the method of the standard codec.

The sound source processing unit (300) extracts audio from the video content and separately isolates moving sound originating from the moving objects. This moving sound is then selectively transmitted to the multiple speaker units (10).

In addition, the sound source processing unit (300) is configured to extract a sound source in comparison with the video information from the video content, separately extract a moving sound source originating from a moving object, and selectively transmit the moving sound source to a plurality of speaker units (10).

As described above, a moving sound source is a sound source that is linked to a moving object. Moving sound sources are extracted separately from moving objects through their synchronized characteristics along with the appearance, expansion, and access of moving objects from the video.

Moving sound sources originating from moving objects have characteristics that differentiate them from other sound sources flowing from the background. While background sound sources have characteristics such as white noise due to their frequency characteristics, moving sound sources have characteristics of having a bandwidth that is concentrated in the mid-low range or a specific wavelength range within the audible frequency band, depending on the type of moving object. The moving sound source of a moving object can be extracted through a separate filter by taking advantage of the characteristic of being modulated through a separate channel, unlike background sound sources or other sound sources.

As illustrated in FIG. 7, the system may include a video extractor (210), a space recognizer (220), and a moving object recognizer (230).

As described above, the video extractor (210) is a technical configuration that extracts video from video information separately from the audio source. The function of extracting only the video from the video information separately from the audio source is self-explanatory, so a separate explanation will be omitted.

Afterwards, the space recognizer (220) individually extracts a background space video from the video extracted separately by the video extractor (210). In addition, the moving object recognizer (230) is configured to individually extract and recognize moving objects from the images extracted separately by the video extractor (210).

As shown in FIGS. 2 and 3, from the extracted video, the moving object recognizer (230) and the space recognizer (220) are configured to recognize the background space video corresponding to the background and the moving object that is not the background by distinguishing and extracting them from the video information. As described above, among the video compression codec standard technologies, based on methods such as mutually separating and compressing and transmitting parts with little change and parts with much change between frames within an image, moving objects can be separately extracted and recognized based on typical patterns of the parts with much change, focusing on parts with much change between frames. Moving objects can be acquired separately, for example, people, cars, aircraft, animals, or other objects that move within the video and attract the user's attention. In addition, in the case of the moving object recognizer (230) and the space recognizer (220), the method by which the video processing unit (200) extracts the moving object from the background space video is to additionally acquire recognition through changes in the position of the moving object along with changes in the size of the moving object, as described below, in addition to the method of the standard codec.

As illustrated in FIG. 3, the spatial recognizer (220), a plurality of virtual grids are partitioned within a background space video, and the spatial movement of a moving object is recognized through the background space video partitioned through the plurality of virtual grids.

A plurality of virtual grids form a plurality of grid-shaped virtual grids in the upper, lower, left, and right directions of video information applied to the display unit (20), and the unit cells of the grid-shaped virtual grid are characterized in that they can be selectively expanded or reduced.

The density of multiple grid-shaped virtual grids, for example, the arrangement of virtual lines of horizontal and vertical virtual orthogonal types, can be processed differently depending on the degree of frame and frame fps or the pixel resolution. The density of the grid can be set differently depending on the temporal processing speed at which the present invention is processed.

Additionally, it is possible to set different settings depending on the speed of movement of the moving object within the video. That is, depending on the speed at which the moving object in FIG. 3 moves in the background space video while a frame of 60 fps is processed, if the speed is fast, the virtual grid can be processed to be greatly expanded, and conversely, if the moving object moves slowly in the background space video, the virtual grid can be processed to be narrow.

The present invention may further include a moving trace recognizer (240).

As illustrated in FIG. 3, the moving trace recognizer (240) is configured to recognize and track the trajectory information of a moving object in a background space video in three dimensions based on the area of a plurality of virtual grids that the moving object occupies in the background space video and the coordinate information of a plurality of virtual grids through which the moving object is transferred in the background space video.

The moving trace recognizer (240) can capture the movement of a moving object on a grid orthogonal to which grid it moves on the background space video on the virtual grid in FIG. 3, and calculates a specific movement pattern according to the type of the moving object and the movement on the grid it moved on so that it can infer a future moving trace, i.e., a trace and trajectory.

As illustrated in FIG. 3, the moving trace recognizer (240) recognizes not only the movement in space based on the movement capture and inference of the trace trajectory, but also whether the movement of the moving object is approaching or moving away and disappearing based on the number of grids occupied by the moving object during the process of moving on moving object #1-1, moving object #1-2, moving object #1-3, and moving object #1-4.

As shown in FIG. 8, the sound source processing unit (300) of the present invention may include a moving sound source separator (310),

As described above, the moving sound source separator (310) is configured to extract a sound source in comparison with the video information and separately extract a moving sound source originating from a moving object.

As described above, a moving sound source is a sound source that is linked to a moving object. The moving sound source is also synchronized with the appearance, expansion, and approach of the moving object from the video, and the moving sound source of the moving object is extracted separately through its synchronization characteristics.

A moving sound source originating from a moving object has distinct characteristics from other sound sources flowing from the background. A background sound source has characteristics such as white noise due to their frequency characteristics, whereas a moving sound source has characteristics of having a bandwidth that is concentrated in the mid-low range or a specific wavelength range within the audible frequency band, depending on the type of moving object. The moving sound source of a moving object can be extracted through a separate filter by taking advantage of the characteristic of being modulated through a separate channel, unlike background sound sources or other sound sources.

As illustrated in FIG. 7, the sound source processing unit (300) may further include a multi-channel allocator (320). The multi-channel allocator (320) is configured to divide the moving sound source of the moving object separately extracted by the moving sound source separator (310) into a plurality of spatial signals and selectively allocate individual channels to each of the plurality of spatial signals.

In addition, the sound source processing unit (300) may further include a physical space synchronizer (330), which is configured to place each of a plurality of speaker units according to preset space designation information within the physical space of the room in which the user is located, and to selectively assign the space signal to each of the plurality of speaker units.

Additionally, the sound source processing unit (300) may further include a moving object sound source tracer (340).

As illustrated in FIG. 1, the moving object sound source tracer (340) recognizes the trajectory information recognized by the moving trace recognizer (240) in three dimensions, and selectively transmits each of a plurality of spatial signals, each of which has an individual channel selectively assigned to a plurality of speaker units (10) arranged in a physical space, thereby providing a user with a three-dimensional sound through a plurality of speaker units (10) in a physical space (room) according to the trajectory information of the moving object.

As illustrated in FIG. 3, when a moving object (see helicopter) is viewed on multiple virtual grids of a background space video, it is a process of moving from the upper left to the lower right center, and in this process, the number of moving objects occupying the grid increases, so the moving object can be interpreted as approaching from the upper left to the lower right center, which is recognized by the moving trace recognizer (240).

A moving sound source of a moving object originates from a moving object, and the moving sound source is individually divided into multiple spatial signals and set to be divided into multiple ones, so that individual channels are selectively assigned, which is managed by the multi-channel allocator (320). Thereafter, as illustrated in FIG. 1, a plurality of speakers (10) may be arranged, for example, a 10FL speaker may be arranged on the front left side of the user, a 10FR speaker may be arranged on the front right side of the user, a 10RL speaker may be arranged on the rear left side of the user, and a 10RR speaker may be arranged on the rear right side of the user. This spatial arrangement is an example of preset spatial designation information, and the physical space synchronizer (330) manages this information. Afterwards, the physical space synchronizer (330) assigns the moving sound source divided into multiple spatial signals above to multiple speakers. The moving object sound source tracer (340) controls the sound of the helicopter in the upper left corner of the image with a 10FL speaker on the front left of the user, and the sound of the helicopter in the lower center of the user's right corner with a 10RR speaker. The frequency band and amplitude of the sound individually transmitted as a spatial signal to each of these speakers are different. For example, the sound of 10FL is set to be small and the frequency is set to the low-pitched range, while the sound of 10RR is set to be large and the frequency band is set to the relatively high-pitched range. The sound transition from the sound of 10FL to 10RR is set to be continuous sound amplification and frequency band transition.

As illustrated in FIG. 1, the physical space synchronizer (330) can be set to virtually assume a predetermined position zone within the room where the user is located, and to place multiple speaker units in front/back/left/right directions around the predetermined position zone using predetermined space designation information.

As shown in FIG. 7, the video processing unit (200), a reflection object recognizer (250) may be further included.

As shown in FIG. 4, in addition to a moving object, in addition to a moving sound source generated from the moving object, if the sourcing of a sound source is performed separately while having the same pattern as the moving sound source but with a time difference from the moving sound source and in the same frequency band, it is possible to detect the presence of a reflection object within the video information as in FIG. 4. The reflection object recognizer (250) estimates that the moving trace recognizer (240) is on the expected path of the moving object, and finally calculates the reflection object based on the pattern of other shapes such as trees, buildings, exterior walls, and cars.

In response to the reflection object generator (241), the sound source processing unit (300) may further include a reflection object sound source tracer (350).

As shown in FIG. 4, by estimating the position of the reflection object, the relative position of the moving object, and the moving trace of the moving object, the movement of the moving sound source and the sound source reflected and bounced off the reflection object are obtained. As described above, when the multi-channel allocator (320) divides the reflected and bounced sound source, i.e., the reflection object sound source, into a plurality of spatial signals and then selectively assigns an individual channel to each of the plurality of spatial signals, the physical space synchronizer (330) can individually transmit these reflection object sound sources to each of the plurality of speaker units (10) to generate individual multi-dimensional sounds for the reflected sound source.

As shown in FIG. 9, the detaching module (360) forms the reflection object sound source file as a bit array of 1 and 0 in the order of columns and rows.

The detaching module (360) sets a preset punching square and applies it to the matrix as described above. The preset punching square is extracted separately from the original information, the reflection object sound source, and stored separately, and the original information, the reflection object sound source, is damaged to that extent.

For matrices with information omitted as much as the preset punching square, the upper detaching module and the lower detaching module are applied respectively.

The upper detaching module is a column that descends independently from the top in a downward direction, and each column descending downward descends independently and separately.

Conversely, the lower detaching module has each column independently rising upward from the bottom, and each column rising upward rises independently and separately.

The lower detaching module does not encroach on the area where the upper detaching module has descended, which means that the upper detaching module and the lower detaching module do not overlap.

The upper detaching module and the lower detaching module tear off the matrix with the information omitted by the preset punching square into the upper and lower modules, respectively, and after that, the original information reflection object sound source is separated into upper and lower modules by the upper detaching module and the lower detaching module, so that the unique information of the reflection object sound source file cannot be known by a third party or external access.

As illustrated in FIG. 7, the video processing unit (200) may further include a ghost object generator (241).

As illustrated in FIG. 5, the spatial recognizer (220) applies a plurality of virtual grids to the video information in a two-dimensional manner.

Thereafter, the moving trace recognizer (310) is configured to additionally calculate the location of the ghost object and its moving trace outside of the video information, if there is a ghost signal, that is, a moving sound source that occurs before the moving object appears in the video, and is placed on an extension of the moving trace.

In accordance with the ghost object generator (241), the sound source processing unit (300) may further include a ghost object sound source tracer (341).

In the extension of the moving object sound source tracer (340), just as a moving sound source is divided into multiple spatial signals and assigned to multiple channels, the ghost sound source tracer (341) also divides and transmits spatial signals individually assigned to multiple speaker units (10), so that the moving sound source can be transmitted starting from the speaker at the rear right, to the front left, and to the front right, based on the user's standard in the example of FIG. 5.

The scope of the present invention is determined by the matters described in the patent claims, and the parentheses used in the patent claims are not written for optional limitation, but are used to indicate clear components, and the description within the parentheses should also be interpreted as essential components.

1. A system for providing multi-dimensional sound within a physical space in which multiple speaker units are arranged by sourcing video information authorized by a display unit, the system comprising:
a video source acquisition unit configured to acquire the video content applied to the display unit;
a video processing unit configured to selectively extract a moving object from the video content and to recognize and track a moving trace of the moving object; and
a sound source processing unit configured to extract audio in contrast to the video from the video content, to separately extract a moving sound originating from the moving object, and to selectively transmit the moving sound to the multiple speaker units.

2. The system of claim 1, wherein the video processing unit comprises:
a video extractor configured to extract video separately from audio within the video content;
a space recognizer configured to independently extract a background space video from the video extracted by the video extractor; and
a moving object recognizer configured to independently extract and recognize the moving object from the video extracted by the video extractor.

3. The system of claim 2, wherein the space recognizer is configured to recognize the spatial movement of the moving object through the background space video divided into a plurality of virtual grids within the background space video and through the segmented background space video.

4. The system of claim 3, wherein the video processing unit further comprises a moving trace recognizer configured to recognize and track trajectory information of the moving object in the background space video in three dimensions based on the area of the plurality of virtual grids that the moving object occupies in the background space video and coordinate information of the plurality of virtual grids to which the moving object is transferred in the background space video.

5. The system of claim 4, wherein the sound source processing unit comprises a moving sound source separator configured to extract audio in contrast to the video from the video content, and separately extract the moving sound originating from the moving object.

6. The system of claim 5, wherein the sound source processing unit further comprises a multi-channel allocator configured to divide the moving sound source of the moving object extracted separately by the moving sound source separator into a plurality of spatial signals, and selectively assigns an individual channel to each of the plurality of spatial signals.

7. The system of claim 6, wherein the sound source processing unit further comprises a physical space synchronizer configured to arrange each of the plurality of speaker units according to preset space designation information within the physical space of the room in which the user is located, and selectively assigns the space signal to each of the plurality of speaker units.

8. The system of claim 7, wherein the sound source processing unit further comprises a moving object sound source tracer configured to recognize the trajectory information recognized by the moving trace recognizer in three dimensions, selectively transmits each of the plurality of spatial signals to which the individual channels are selectively assigned to the plurality of speaker units arranged in the physical space, and provides the user with a multi-dimensional sound through the plurality of speaker units in the physical space in accordance with the trajectory information of the moving object moving.

9. The system of claim 7, wherein the physical space synchronizer is configured to define a predetermined positioned zone virtually within the room where the user is located, and arrange the multiple speaker units in front, rear, left, and right directions around the predetermined positioned zone based on the predefined spatial configuration information.

10. The system of claim 3, wherein the plurality of virtual grids form a plurality of grid-shaped virtual grids in the upper, lower, left, and right directions of the video information applied to the display unit, and is characterized in that the unit cells of the grid-shaped virtual grid can be selectively expanded or reduced.
